(19) United States
(12) Patent Application Publication
(10) Pub. No.: US 2026/0126155 A1
(43) Pub. Date: May 7, 2026

(54) WORK LIGHT

(71) Applicant: TECHTRONIC CORDLESS GP, Anderson, SC (US)

(72) Inventors: Patrick F. Brown, Greenville, SC (US); Antoinette Louw, Greenville, SC (US); Patrick B. Murphy, Anderson, SC (US); Julia Diltz, Chicago, IL (US); Robert C. Hawkins, Anderson, SC (US)

(21) Appl. No.: 18/939,173

(22) Filed: Nov. 6, 2024

(51) Int. Cl. F21L 4/04; F21V 21/096; F21V 21/14; F21V 21/28; F21V 29/76; F21Y 105/16; F21Y 115/10

(52) U.S. Cl. CPC F21L 4/045; F21V 21/0965; F21V 21/145; F21V 21/28; F21V 29/763; F21Y 2105/16; F21Y 2115/10

(57) ABSTRACT

A work light may include a light source head and a body. The light source head includes a first magnetic element and the body includes a battery receptacle configured to receive a battery for powering the light source head, a mount surface configured to mount the work light to a structure, and a second magnetic element supported adjacent the mount surface. The light source head is movable relative to the body between a first state, in which the first magnetic element of the light source head is engaged with the second magnetic element of the body, and a second state, in which the light source head is spaced away from the mount surface and the second magnetic element is configured to engage the structure.

### TECHNICAL FIELD

The present disclosure relates to a work light, and more particularly to a battery-powered work light.

### BACKGROUND

Work lights can be used to illuminate work areas that are otherwise difficult to light. Examples of these areas include work sites, ceiling spaces, basement areas, and the like.

### SUMMARY

The present disclosure provides, in one aspect, a work light including a light source head including a first magnetic element; and a body including a battery receptacle configured to receive a battery for powering the light source head, a mount surface configured to mount the work light to a structure, and a second magnetic element supported adjacent the mount surface, wherein the light source head is movable relative to the body between a first state, in which the first magnetic element of the light source head is engaged with the second magnetic element of the body, and a second state, in which the light source head is spaced away from the mount surface and the second magnetic element is configured to engage the structure.

The present disclosure provides, in another aspect, a work light including a light source head; and a body including a battery receptacle configured to receive a battery for powering the light source head, a mount surface configured to mount the work light to a structure, and a magnet supported adjacent the mount surface, the magnet configured to alternately engage the light source head and the structure.

The present disclosure provides, in another aspect, a work light including a light source head including a light source, a lens covering the light source, and a first magnetic element; and a body pivotably coupled to the light source head and including a battery receptacle configured to receive a battery for powering the light source of the light head, a mount surface configured to mount the work light to a structure, and a second magnetic element adjacent the mount surface, wherein the light source head is pivotable relative the body to a state where the lens faces the mount surface and the first magnetic element of the light source interacts with the second magnetic element of the body.

Other features and aspects of the disclosure will become apparent by consideration of the following detailed description and accompanying drawings.

### BRIEF DESCRIPTION OF THE DRAWINGS

FIG. 1 is a perspective view of a work light according to an embodiment of the disclosure, illustrating the work light in a first, folded state.

FIG. 2 is a perspective view of the work light of FIG. 1, illustrating the work light in a second, unfolded state.

FIG. 3 is a perspective view of the work light of FIG. 1, illustrating the work light hanging from a structure.

FIG. 4 is a side plan view of the work light of FIG. 1, illustrating a light source head pivoting relative to a body of the work light through an angle of rotation.

FIG. 5 is a cross-sectional perspective view of the work light of FIG. 1, illustrating a detent mechanism of the light source head.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

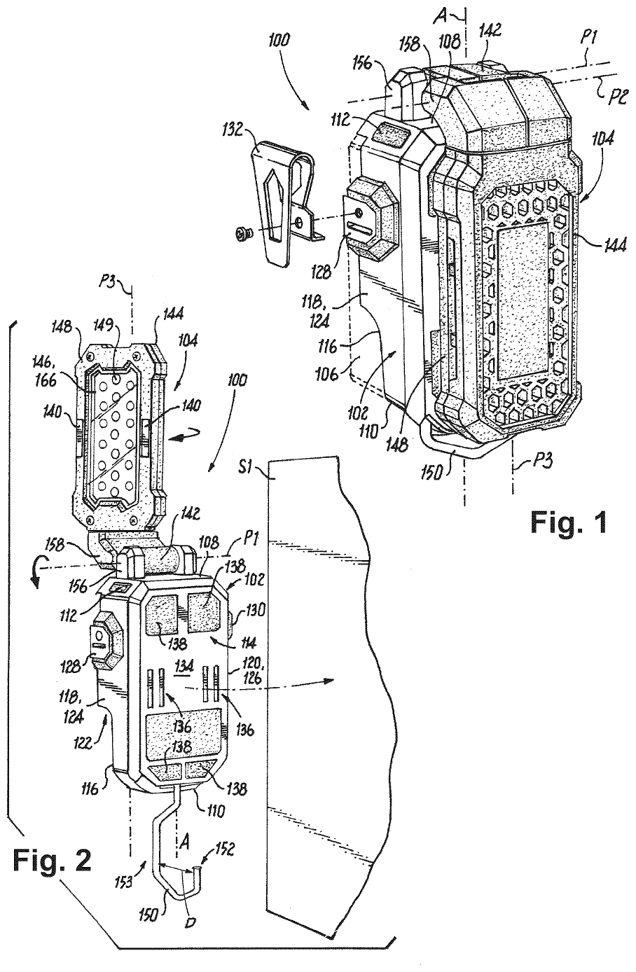

FIG. 1 illustrates a work light 100 according to an embodiment of the present disclosure. The illustrated work light 100 is battery-powered. The work light 100 is sized and shaped for one-handed operation and transport. The work light 100 includes a body 102 and a light source head 104 coupled to the body 102. A battery 106 is also removably coupled to the body 102.

The illustrated battery 106 is a power tool battery, which may be used with other power tools (e.g., an electric drill) and includes a voltage of, for example, 12 volts. The battery 106 also has a Li-ion chemistry. In other embodiments, the battery 106 may have other voltages and chemistries.

With continued reference to FIG. 1, the body 102 includes a first end 108, a second end 110 opposite the first end 108, and a longitudinal axis A extending between the first end 108 and the second end 110. In the illustrated embodiment, the first end 108 supports a user interface. The illustrated user interface includes one or more controls, such as a power button 112. In some embodiments, the work light 100 may further include one or more indicators, such as one or more battery power indicators, disposed on the body 102.

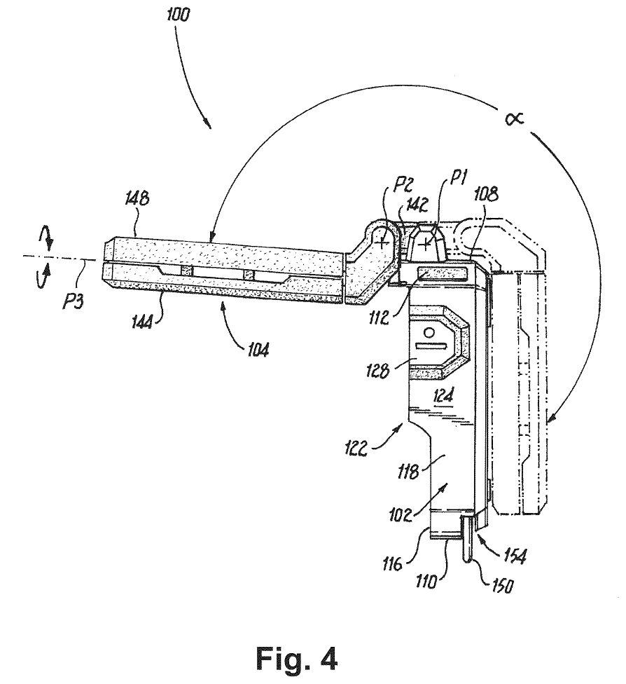

The body 102 further incudes a first or front face 114, a second or rear face 116 (FIG. 4), and opposing sides 118, 120. The two opposing sides 118, 120 extend between the first end 108 and the second end 110 of the body 102.

With reference to FIGS. 2 and 4, the body 102 of the work light 100 further includes a battery receptacle 122 on the rear face 116 between the first end 108 and the second end 110. The battery receptacle 122 receives at least a portion of the battery 106 (FIG. 1) to power the work light 100. Specifically, the battery 106 slides into the battery receptacle 122 along a direction parallel to the longitudinal axis A of the body 102. In other embodiments, the battery receptacle 122 may be located elsewhere on the body 12. In still other embodiments, the battery receptacle 122 may be positioned within the body 12. In such embodiments, the battery 106 may be a dedicated battery that is not removable from the body 102.

Each opposing side 118, 120 of the body 102 includes a grip section 124, 126 disposed thereon and a clip mount 128, 130 to which a clip 132 may mount to. Specifically, the clip 132 may mount to either the clip mount 128 or the clip mount 130 via a fastener or some other similar quick disconnect mechanism. As briefly discussed above, the work light 100 may be sized and shaped for single-handed operation and transport, making it sufficiently sized to be clipped onto a user's pocket, tool belt, work bag, or other similar region via the clip 132.

With reference to FIG. 2, the body 102 further includes a mount surface 134 defined on the front face 114 between the two opposing sides 118, 120. The mount surface 134 allows a user to alternately mount the work light 100 to one or more structures (e.g., structure S1) and maintain the light source head 104 against the body 102, as explained in further detail below. In the illustrated embodiment, the body 102 includes two pairs of ferromagnetic members 136 coupled thereto and disposed on the mount surface 134. In other embodiments, there may be more or fewer than two pairs of ferromagnetic members 136. The ferromagnetic members 136 may also be referred to as magnets.

With continued reference to FIG. 2, at least a portion of each ferromagnetic member 136 is exposed on the mount surface 134. Furthermore, the ferromagnetic members 136 are flush with the front face 114. In other embodiments, however, the ferromagnetic members 136 may be completely disposed within and concealed by the body 102 (i.e., sub-flush relative to the front face 114). In yet other embodiments, each ferromagnetic member 136 may extend beyond the front face 114 (i.e., not flush). The ferromagnetic members 136 may also be covered with a relatively soft material (e.g., rubber) to inhibit marring the structure S1 or the light source head 104. One pair of ferromagnetic members 136 are adjacent the first side 118 of the body 102, while the other pair of ferromagnetic members 136 are adjacent the second side 120 of the body 102. In the illustrated embodiment, each of the ferromagnetic members 136 extends in a direction that is parallel with the longitudinal axis A of the body 102 (shown in FIG. 2). The ferromagnetic members 136 form magnetic fields that are attracted to surfaces of the structure S1, such as a vertical work surface (e.g., a wall, strut, cabinet, etc.) that at least has a portion that is sufficiently magnetic (such as a structure made at least in part of steel, iron, or the like). The ferromagnetic members 136 are also attracted to the light source head 104, such that the ferromagnetic members 136 are configured to alternately engage the light source head 104 and the structure S1. A plurality of pads 138 are also disposed on the front face 114 adjacent the ferromagnetic members 136 and are configured to directly engage the structure S1. Specifically, the pads 138 extend beyond the front face 114 (FIG. 4) and provide grip (i.e., increased friction) between the structure S1 and the work light 100 to avoid inadvertent slippage of the work light 100 relative to the structure S1. The pads 138 may be composed of an elastomeric material that is softer than the material of the body 102 to avoid inadvertently marring the structure S1.

With reference to FIGS. 1 and 2, the light source head 104 is pivotably connected to the body 102. In the illustrated embodiment, the light source head 104 is coupled to the first end 108 of the body 102, such that the work light 100 is movable between a first, folded state (FIG. 1) and a second, unfolded state (FIG. 2). The light source head 104 may pivot relative to the body 102 through an angle of rotation α (FIG. 4). In the illustrated embodiment, the angle of rotation α is up to and including 270-degrees. In the folded state, the light source head 104 is adjacent the body 102. Specifically, the light source head 104 is engaged with (i.e., interfaced with) and abuts the body 102. In the unfolded state, the light source head 104 is spaced away from the body 102. The light source head 104 includes a set of ferrous metal contacts 140 (e.g., a first magnetic element) that align with and engage the ferromagnetic members 136 (e.g., a second magnetic element) via a magnetic force when the light source head 104 is pivoted toward the body 102 and the work light 100 is in the folded state. As a result, a force sufficient to overcome the magnetic force between ferromagnetic members 136 and the ferrous metal contacts 140 is required to move the light source head 104 away from the body 102 (i.e., move the work light 100 from the folded state to the unfolded state).

Although the ferromagnet members 136 of the illustrated embodiment are disposed on the body 102 and the metal contacts 140 of the illustrated embodiment are disposed on the light source head 104, in other embodiments, the ferromagnet members 136 may alternatively be disposed on the light source head 104 and the metal contacts 140 may be disposed on the body 102.

With continued reference to FIGS. 1 and 2, the light source head 104 is coupled to the body 102 by a linkage 142. In the illustrated embodiment, the light source head 104 is coupled to the body 102 by a single linkage 142 located between the body 102 and the light source head 104, although other embodiments may include additional pivotable linkage connections between the body 102 and the light source head 104. Specifically, the linkage 142 is coupled to and disposed between a first hinge 156 disposed on the first end 108 of the body 102 and a second hinge 158 disposed on the light source head 104. The light source head 104 is pivotable relative to the body 102 about a first pivot axis P1 defined at the first hinge 156, a second pivot axis P2 defined at the second hinge 158 and spaced apart from the first pivot axis P1, and a third pivot axis P3. The first and second pivot axes P1, P2 enable the light source head 104 to pivot through the angle of rotation α. In the illustrated embodiment, the first pivot axis P1 and second pivot axis P2 are parallel to each other and extend in a direction that is perpendicular to the longitudinal axis A of the body 102.

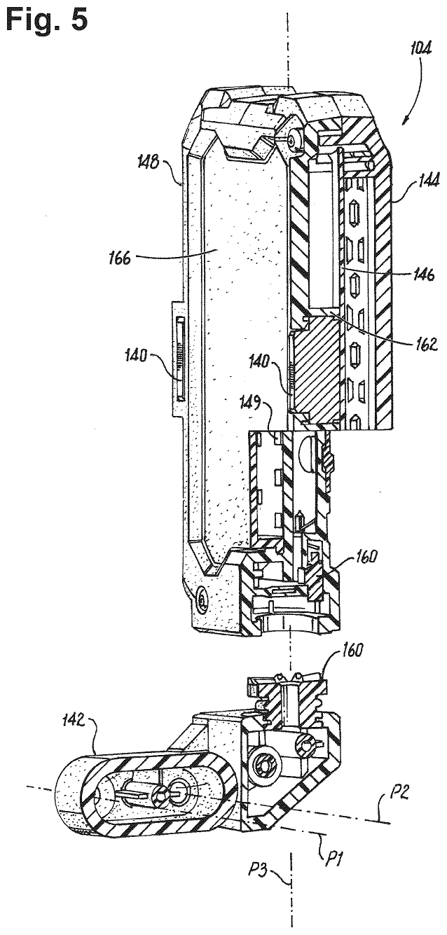

The third pivot axis P3 extends in a direction that is parallel to the longitudinal axis A when the work light 100 is in the folded state (i.e., the light source head 104 is folded onto the body 102). Also, the third pivot axis P3 extends in a direction perpendicular to the first pivot axis P1 and the second pivot axis P2. The third pivot axis P3 allows the light source head 104 to rotate 360-degrees relative to the linkage 142. A detent mechanism 160 (FIG. 5) may allow the light source head 104 to rotate to discrete angles about the third pivot axis P3. For example, in some embodiments, the light source head 104 may be enabled to rotate to discrete positions every 30-degrees about the third pivot axis P3. In other embodiments, the light source head 104 may rotate to an infinite number of positions about the third pivot axis P3.

When the work light 100 is unfolded, the light source head 104 may pivot about the third pivot axis P3, such that light may be emitted in various directions relative to the body 102, such as in directions perpendicular to the front face 114, the rear face 116, the first side 118, and the second side 120. As explained in further detail below, light may even be emitted away from the front face 114 when the light source head 104 is in the folded state.

The light source head 104 includes a rear or honeycomb housing 144 (FIG. 1), a planar light panel 146 (FIG. 2), and a front housing or head frame 148 surrounding the light panel 146 to mitigate damage to the light panel 146 from inadvertently dropping the work light 100. A lens 166 also covers the planar light panel 146. The planar light panel 146 is disposed between the honeycomb housing 144 and the head frame 148. Furthermore, the planar light panel 146 is recessed (i.e., sub-flush) relative to the head frame 148. The honeycomb housing 144 is coupled to the planar light panel 146 opposite the head frame 148. The honeycomb housing 144 facilitates heat dissipation generated from the planar light panel 146 to surrounding environment. Specifically, the light panel 146 includes a light source.

The illustrated light source is a plurality of light-emitting diodes (LEDs) 149 that generate heat when emitting light. As such, the light panel 146 may absorb the heat and dissipate the heat through apertures in the honeycomb housing 144. In other embodiments, the light panel 146 includes additional or alternative light sources. As shown in FIG. 2, the LEDs 149 are arranged in three parallel columns. In other embodiments, the LEDs 149 may be arranged in other configurations.

The metal contacts 140 are coupled to the head frame 148 on either side of the light panel 146. Specifically, the metal contacts 140 are coupled to the head frame 148 without fasteners. Instead, the metal contacts 140 are disposed within a pocket 162 of the head frame 148 and trapped between the planar light panel 146 and the head frame 148. The metal contacts 140 are also dedicated components for interacting with the ferromagnetic members 136 of the body 102. That is, the ferromagnetic members 136 are configured and arranged to interact with the metal contacts 140, not with fasteners (e.g., screws) used to assemble the light source head 104.

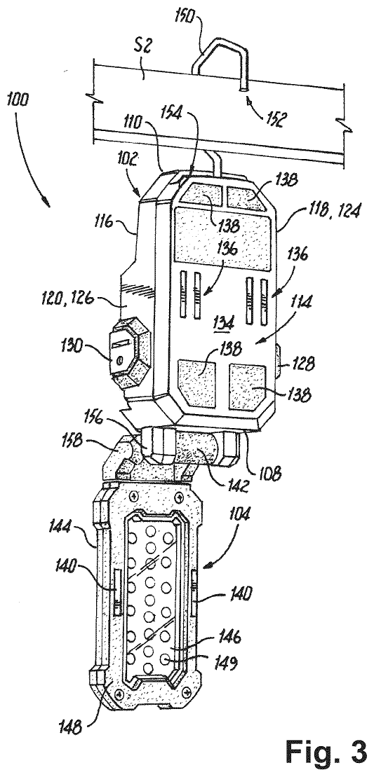

In situations where the structure S1 is made of a material that is not magnetic (such as wood) or is very weakly magnetic, the ferromagnetic members 136 may not work at all or may be insufficient to mount the work light 100 to the structure S1. In such instances, a user may instead hang the work light 100 by a hook 150, as shown in FIG. 3. The hook 150 includes an open end 152 that is configured to receive a separate structure S2, such as a horizontal support member (e.g., rod, pipe, dowel, lumber, etc.). As shown in FIG. 2, a distance D from the open end 152 to a leg 153 of the hook 150 is not less than 1.5 inches. That is, the distance D may be 1.5 inches or more, and more particularly, may be 1.5 inches to approximately 5.0 inches. The hook 150 is slidably received within a slot 154 in the body 102. Specifically, the hook 150 is slidable relative to the body 102 along the longitudinal axis A between a retracted position (FIG. 1) and an extended position (FIG. 2). In the retracted position, the open end 152 of the hook 150 is substantially received within the slot 154 of the body 102. In the extended position, the open end 152 is spaced away from the body 102 and is configured to receive the structure S2. Also, when the hook 150 is in the extended position, the hook 150 is pivotable about the longitudinal axis A.

In operation, the light panel 146 is selectively powered by the battery 106. The light panel 146 may be operable in different modes by actuating the power button 112. More specifically, the light panel 146 may produce light having a first brightness while in a first mode and a second brightness lower than the first brightness while in a second mode. In other embodiments, the light panel 146 may be operable in more than the first and second modes. In some embodiments, the user interface may also include a separate mode button to cycle through modes.

When the work light 100 is in the folded state, the light panel 146 and the lens 166 may be facing directly at the front face 114 or directly away from the front face 114. For example, if a user desires to protect the light panel 146 during storage of the work light 100, the light source head 104 may be rotated about the third pivot axis P3 during the unfolded state and then rotated about the first and second pivot axes P1, P2, such that the light panel 146 directly faces the front face 114 when the work light 100 is moved to the folded state. At this point, the ferromagnetic members 136 attract the metal contacts 140 and the mount surface 134 engages the light source head 104. A force sufficient to overcome the magnetic force between the ferromagnetic members 136 attract the metal contacts 140 is required to move the light source head 104 away from the body 102.

In other uses, a user may desire to emit light with the work light 100 even in the folded state. Here, a user may rotate the light source head 104 about the third pivot axis P3 180-degrees in the unfolded state and then refold the light source head 104 toward the front face 114 (or mount surface 134). This time, the honeycomb housing 144 directly faces the front face 114 and the light panel 146 faces directly away from the front face 114, allowing light to be emitted directly away from the front face 114 even when the light source head 104 is in the folded state. The light panel 146, and the light source head 104 itself, may be any size, but the illustrated embodiment of the light source head 104 defines a footprint that is approximately the same size as the front face 114 of the body 102.

Returning to FIG. 2 the work light 100 is shown mounted to the structure S1. Here, the work light 100 is in the unfolded state, thereby exposing the mount surface 134 and allowing the mount surface 134 to alternately engage other magnetic surfaces, such as the structure S1. A force sufficient to overcome the magnetic force between the mount surface 134 and the structure S1 is required to pull the work light 100 off the structure S1. Once disengaged, a user may, for example, move the hook 150 to the extended position and hang the work light 100 from the structure S2 (FIG. 3).

Although particular embodiments have been shown and described, other alternative embodiments will become apparent to those skilled in the art and are within the intended scope of the independent aspects of the disclosure. Various features of the disclosure are set forth in the claims.

1. A work light comprising:
a light source head including a first magnetic element; and
a body including:
a battery receptacle configured to receive a battery for powering the light source head,
a mount surface configured to mount the work light to a structure, and
a second magnetic element supported adjacent the mount surface,
wherein the light source head is movable relative to the body between a first state, in which the first magnetic element of the light source head is engaged with the second magnetic element of the body, a second state, in which the light source head is spaced away from the mount surface and the second magnetic element is configured to engage the structure, and a third state, in which the light source head abuts the mount surface and the first magnetic element faces away from the mount surface.

2. The work light of claim 1, wherein the light source head is pivotably coupled to the body.

3. The work light of claim 2, wherein the light source head is pivotable relative to the body through an angle of rotation of about 270-degrees.

4. The work light of claim 2, further comprising a linkage that pivotably couples the light source head to the body, wherein the linkage defines a first pivot axis and a second pivot axis that is spaced apart from and parallel to the first pivot axis.

5. The work light of claim 4, wherein the light source head is also rotatable relative to the linkage about a third pivot axis that is perpendicular to the first and second pivot axes.

6. The work light of claim 1, wherein the body also includes a user interface to control operation of the work light.

7. The work light of claim 1, further comprising a hook that is slidably received within a slot in the body, wherein the hook is slidable relative to the body between a retracted position, in which an open end of the hook is substantially received within the body, and an extended position, in which the open end of the hook is spaced away from the body.

8. The work light of claim 1, wherein the light source head also includes a planar light panel and a head frame disposed around the planar light panel, and wherein the first magnetic element is coupled to the head frame.

9. The work light of claim 8, wherein the light source head further includes a honeycomb housing coupled to the planar light panel opposite the head frame, and wherein heat generated from the planar light panel may is configured to be dissipated through apertures of the honey comb housing.

10. The work light of claim 8, wherein the light source head further includes a lens covering the planar light panel, and wherein the lens faces the mount surface when the light source head is in the first state.

11. The work light of claim 1, wherein the first magnetic element is a metal contact, and wherein the second magnetic element is a magnet.

12. A work light comprising:
a light source head; and
a body including:
a battery receptacle configured to receive a battery for powering the light source head, the battery receptacle positioned on a first side of the body,
a mount surface configured to mount the work light to a structure, the mount surface positioned on a second side of the body opposite the first side, and
a magnet supported adjacent the mount surface, the magnet configured to alternately engage the light source head and the structure.

13. The work light of claim 12, wherein the light source head is pivotably coupled to the body.

14. The work light of claim 13, further comprising a linkage that pivotably couples the light source head to the body, wherein the linkage defines a first pivot axis, a second pivot axis spaced apart from and parallel to the first pivot axis, and a third pivot axis that is perpendicular to the first and second pivot axes.

15. The work light of claim 12, wherein the light source head includes a first magnetic element configured to interact with the magnet.

16. The work light of claim 15, wherein the light source head also includes a planar light panel and a head frame disposed around the planar light panel, and wherein the first magnetic element is coupled to the head frame.

17. The work light of claim 16, wherein the light source head further includes a lens covering the planar light panel, and wherein the lens faces the mount surface when the magnet of the body engages the first magnetic element of the light source head.

18. A work light comprising:
a light source head including a light source, a lens covering the light source, and a first magnetic element; and
a body pivotably coupled to the light source head and including:
a battery receptacle configured to receive a battery for powering the light source of the light head,
a mount surface configured to mount the work light to a structure, and
a second magnetic element adjacent the mount surface,
wherein the light source head is pivotable relative the body to a state where the lens faces the mount surface and the first magnetic element of the light source interacts with the second magnetic element of the body.

19. The work light of claim 18, further comprising a linkage that pivotably couples the light source head to the body, wherein the linkage defines a first pivot axis, a second pivot axis spaced apart from and parallel to the first pivot axis, and a third pivot axis that is perpendicular to the first and second pivot axes.

20. The work light of claim 18, wherein the first magnetic element is a metal contact, and wherein the second magnetic element is a magnet.
